(19) United States
(12) Patent Application Publication
(10) Pub. No.: US 2026/0294722 A1
(43) Pub. Date: Oct. 1, 2026

(54) DENTAL RESTORATION FUNNEL DEVICE

(71) Applicant: Mike Abougoush, Peachland (CA)

(72) Inventor: Mike Abougoush, Peachland (CA)

(21) Appl. No.: 19/091,321

(22) Filed: Mar. 26, 2025

(51) Int. Cl. A61G 15/14; A61C 17/06

(52) U.S. Cl. CPC A61G 15/14; A61C 17/06

(57) ABSTRACT

A dental restoration funnel device for holding a dental restoration during preparation of the dental restoration includes a dental suction machine that has a high volume suction hose. A funnel is removably attachable to the high volume suction hose. The funnel has a foraminous floor and a dental restoration can placed upon the foraminous floor. Furthermore, the funnel is in fluid communication with the high volume suction hose. The foraminous floor can pass air through the foraminous floor and into the high volume suction hose for suctionally removing debris from the dental restoration during preparation of the dental restoration.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to funnel devices and more particularly pertains to a new funnel device for holding a dental restoration during preparation of the dental restoration. The device includes a dental suction machine that includes a high pressure suction hose and a funnel that is removably attachable to the high pressure suction hose. The funnel has a foraminous floor upon which a dental restoration can be placed. The foraminous floor is in fluid communication with the high pressure suction hose such that debris from preparation work on the dental restoration can pass through the foraminous floor to be collected by the high pressure suction hose.

### (2) Description of Related Art Including Information Disclosed under 37 CFR 1.97 and 1.98

The prior art relates to funnel devices including: a vacuum funnel filter device that includes a filtrate container and a funnel that is insertable into the filtrate container and a vacuum intake that is integrated into the filtrate container; a variety of funnel devices that each at least includes a funnel and a screen which filters particulates from a fluid that passes through the funnel; a funnel device that has a foraminous interior wall for filtering particulates from a fluid that passes through the foraminous interior wall. In no instance does the prior art disclose a dental restoration funnel device that includes a dental suction machine that includes a high volume suction hose and a funnel that can be attached to the high volume suction hose which includes a foraminous floor upon which a dental restoration can be placed to enable debris and fluids which result from preparation work on the dental restoration to be collected by the high volume suction hose.

### (h) BRIEF SUMMARY OF THE INVENTION

An embodiment of the disclosure meets the needs presented above by generally comprising a dental suction machine that has a high volume suction hose. A funnel is removably attachable to the high volume suction hose. The funnel has a foraminous floor and a dental restoration can placed upon the foraminous floor. Furthermore, the funnel is in fluid communication with the high volume suction hose. The foraminous floor can pass air through the foraminous floor and into the high volume suction hose for suctionally removing debris from the dental restoration during preparation of the dental restoration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dental restoration funnel device according to an embodiment of the disclosure.

FIG. 2 is a phantom in-use view of a funnel of an embodiment of the disclosure.

FIG. 3 is a top view of a funnel of an embodiment of the disclosure.

FIG. 4 is a top perspective view of a funnel of an embodiment of the disclosure.

### (j) DETAILED DESCRIPTION OF THE INVENTION

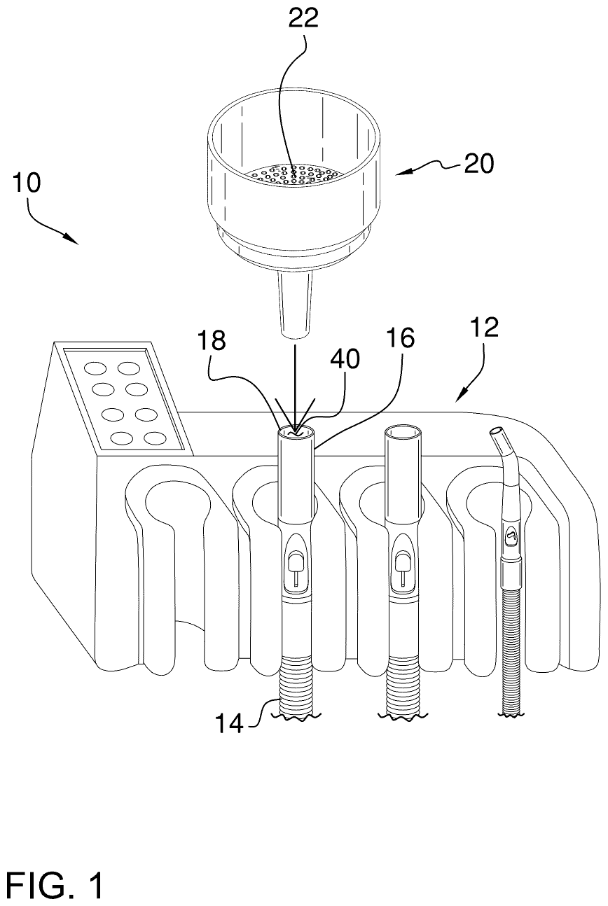

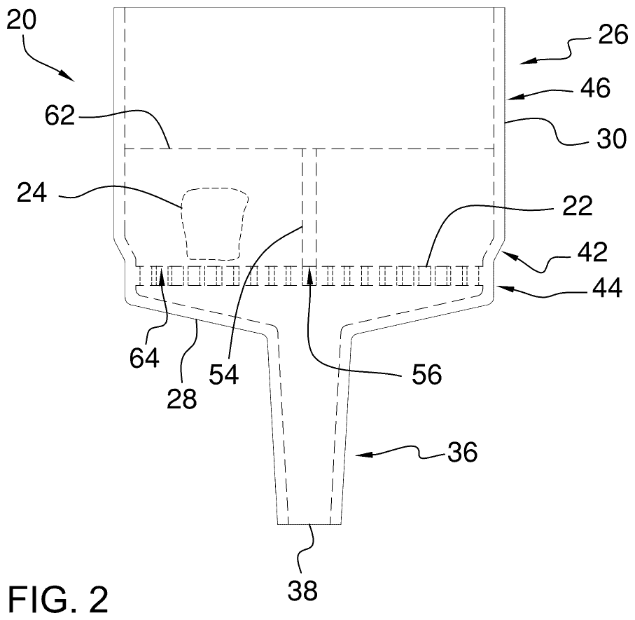

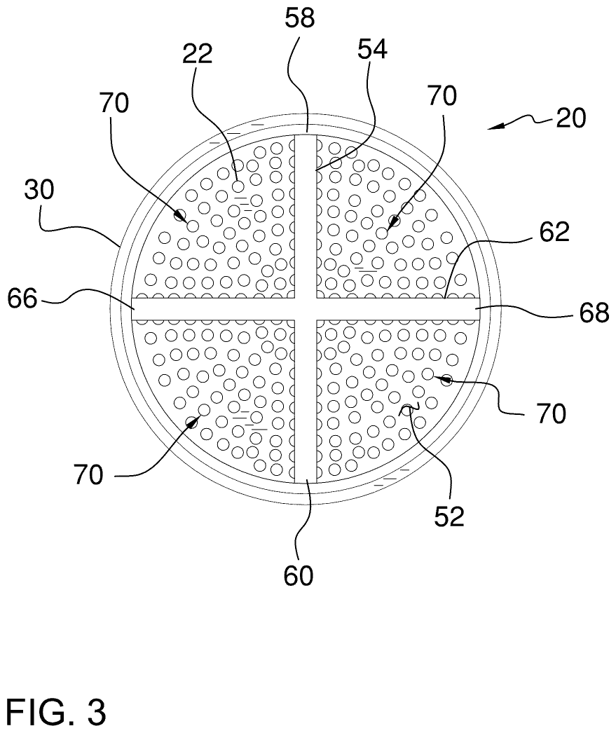

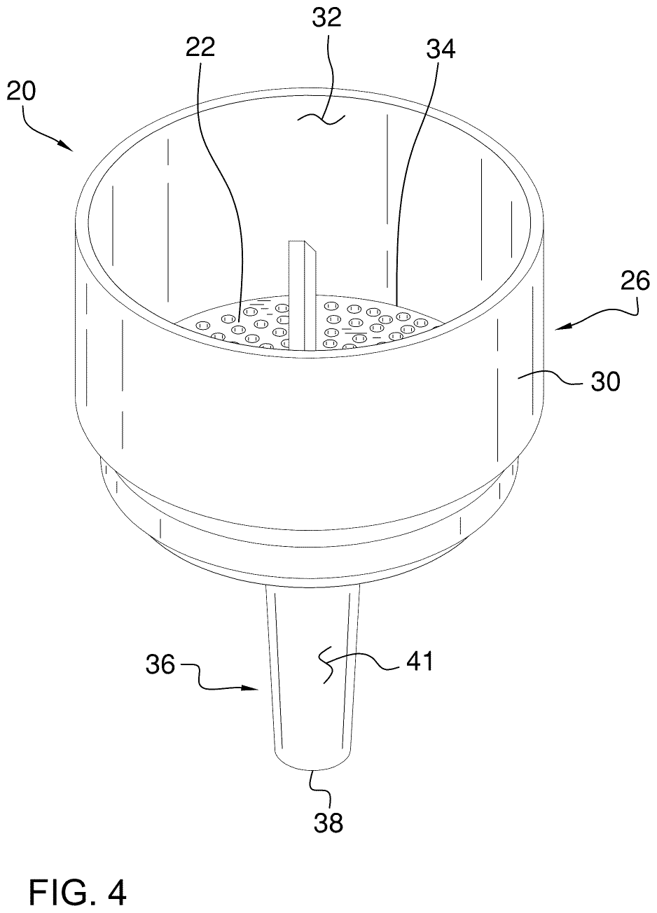

With reference now to the drawings, and in particular to FIGS. 1 through 4 thereof, a new funnel device embodying the principles and concepts of an embodiment of the disclosure and generally designated by the reference numeral 10 will be described.

As best illustrated in FIGS. 1 through 4, the dental restoration funnel device 10 generally comprises a dental suction machine 12 that has a high volume suction hose 14. The high volume suction hose 14 has a sleeve 16 which is coupled to the high volume suction hose 14. Additionally, the sleeve 16 has a distal end 18 and the distal end 18 is open. The dental suction machine 12 may be an electromechanical dental suction machine of any conventional design that would commonly be employed by a dentist in a dental office.

A funnel 20 is removably attachable to the high volume suction hose 14 such that the funnel 20 is in fluid communication with the high volume suction hose 14. The funnel 20 has a foraminous floor 22 and a dental restoration 24 can placed upon the foraminous floor 22. Furthermore, the foraminous floor 22 passes air through the foraminous floor 22 and into the high volume suction hose 14 for suctionally removing debris from the dental restoration 24 during preparation of the dental restoration 24. The funnel 20 has a cylinder portion 26 and the cylinder portion 26 has a bottom wall 28 and an outer wall 30 extending upwardly from the bottom wall 28. The funnel 20 may be comprised of a rigid and heat resistant material, including but not being limited to stainless steel, such that the funnel 20 can be sterilized in an autoclave or other type of heat sterilizing device. Alternatively, the funnel 20 may be comprised of a rigid material, including but not being limited to plastic, such that the funnel 20 can be sterilized in a cold bath or other sterilizing means that does not involve the application of heat.

The outer wall 30 of the cylinder portion 26 has an inside surface 32 and the foraminous floor 22 has a perimeter edge 34. The perimeter edge 34 is coupled to the inside surface 32 of the outer wall 30 of the cylinder portion 26. Additionally, the foraminous floor 22 is spaced from the bottom wall 28 of the cylinder portion 26. Furthermore, the foraminous floor 22 lies on a plane that is oriented parallel to the bottom wall 28 of the cylinder portion 26.

The funnel 20 has a spout portion 36 which is coupled to and extends downwardly from the bottom wall 28 of the cylinder portion 26. The spout portion 36 has a distal end 38 of the spout portion 36 with respect to the bottom wall 28 and the spout portion 36 tapers between the bottom wall 28 and the distal end 38 of the spout portion 36. Additionally, the distal end 38 of the spout portion 36 is insertable into the distal end 18 of the sleeve 16 on the high volume suction hose 14. The sleeve 16 has an interior surface 40 and the spout portion 36 has an outside surface 41. Furthermore, the outside surface 41 of the spout portion 36 frictionally engages the interior surface 40 of the sleeve 16 when the distal end 38 of the spout portion 36 is inserted into the distal end 18 of the sleeve 16 for retaining the spout portion 36 in the sleeve 16.

The outer wall 30 of the cylinder portion 26 has a medial section 42 angling outwardly between a lower section 44 and an upper section 46. The outer wall 30 has a top edge 48 defining an opening 50 into the cylinder portion 26 of the funnel 20. The lower section 44 intersects the bottom wall 28 and the medial section 42 is positioned closer to the bottom wall 28 than the top edge 48 of the outer wall 30. The lower section 44 has a diameter that is less than a diameter of the upper section 46. Additionally, the foraminous floor 22 is aligned with the medial section 42 and the foraminous floor 22 has a top surface 52.

A first divider 54 is provided which has a bottom edge 56 extending between and being perpendicular to each of a first edge 58 and a second edge 60. The bottom edge 56 is coupled to the top surface 52 of the foraminous floor 22 and the first divider 54 extends upwardly from the foraminous floor 22. The first divider 54 is centrally located on the foraminous floor 22 and the first divider 54 bisects the foraminous floor 22. Additionally, each of the first edge 58 and the second edge 60 is coupled to the inside surface 32 of the outer wall 30 of the cylinder portion 26 of the funnel 20. The first divider 54 has a height that is less than a height of the upper section 46 of the outer wall 30 of the cylinder portion 26 of the funnel 20.

A second divider 62 is provided which has a lower edge 64 extending between and being perpendicular to each of a primary edge 66 and a secondary edge 68. The lower edge 64 is coupled to the top surface 52 of the foraminous floor 22 and the second divider 62 extends upwardly from the foraminous floor 22. The second divider 62 is centrally located on the foraminous floor 22 and the second divider 62 bisecting the foraminous floor 22. Furthermore, the second divider 62 is oriented perpendicular to the first divider 54. The first divider 54 and the second divider 62 define quadrants 70 of the foraminous floor 22 and each of the quadrants 70 can contain a respective one of a plurality of the dental restorations 24. Additionally, the second divider 62 has a height that is equal to the height of the first divider 54.

In use, the spout portion 36 of the funnel 20 is inserted into the distal end 18 of the sleeve 16 on the high volume suction hose 14 such that the funnel 20 is vertically oriented and the foraminous floor 22 lies on a horizontal plane. The dental suction machine 12 is turned on and the dental restoration 24 is held over the funnel 20 while the dental restoration 24 is abraded to shape the dental restoration 24. The debris that results from the abrasion of the dental restoration 24 is sucked into the funnel 20 and passes through the foraminous floor 22 to be collected by the dental suction machine 12. The dental restoration 24 is subsequently placed upon the foraminous floor 22 to rinse etchant that has been applied to the dental restoration 24 with water which is subsequently collected by the high volume suction hose 14. The dental restoration 24 is left on the foraminous floor 22 until the dental restoration 24 has dried and is ready for application.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental restoration funnel device for holding a dental restoration while the dental restoration is being prepared for installation, said device comprising:
a dental suction machine having a high volume suction hose; and
a funnel being removably attachable to said high volume suction hose, said funnel having a foraminous floor wherein said foraminous floor is configured to have the dental restoration placed upon said foraminous floor, said funnel being in fluid communication with said high volume suction hose wherein said foraminous floor is configured to pass air through said foraminous floor and into said high volume suction hose for suctionally removing debris from the dental restoration during preparation of the dental restoration.

2. The dental restoration funnel device according to claim 1, further comprising:
said funnel having a cylinder portion;
said cylinder portion having a bottom wall and an outer wall extending upwardly from said bottom wall;
said outer wall having an inside surface;
said foraminous floor having a perimeter edge; and
said perimeter edge being coupled to said inside surface of said outer wall of said cylinder portion.

3. The dental restoration funnel device according to claim 2, further comprising said foraminous floor being spaced from said bottom wall of said cylinder portion.

4. The dental restoration funnel device according to claim 2, further comprising said foraminous floor lying on a plane being oriented parallel to said bottom wall of said cylinder portion.

5. The dental restoration funnel device according to claim 2, further comprising said funnel having a spout portion being coupled to and extending downwardly from said bottom wall of said cylinder portion.

6. The dental restoration funnel device according to claim 5, further comprising:
said high volume suction hose having a sleeve being coupled to said high volume suction hose;
said sleeve having a distal end;
said distal end being open;
said spout portion having a distal end of said spout portion with respect to said bottom wall;
said spout portion tapering between said bottom wall and said distal end of said spout portion; and
said distal end of said spout portion being insertable into said distal end of said sleeve on said high volume suction hose.

7. The dental restoration funnel device according to claim 6, further comprising:
said sleeve having an interior surface;
said spout portion having an outside surface; and
said outside surface of said spout portion frictionally engaging said interior surface of said sleeve when said distal end of said spout portion is inserted into said distal end of said sleeve for retaining said spout portion in said sleeve.

8. The dental restoration funnel device according to claim 2, further comprising said outer wall of said cylinder portion having a medial section angling outwardly between a lower section and an upper section.

9. The dental restoration funnel device according to claim 8, further comprising:
said outer wall having a top edge defining an opening into said cylinder portion of said funnel;
said lower section intersecting said bottom wall;
said medial section being positioned closer to said bottom wall than said top edge of said outer wall; and
said lower section having a diameter being less than a diameter of said upper section, said foraminous floor having a top surface.

10. The dental restoration funnel device according to claim 8, further comprising said foraminous floor being aligned with said medial section.

11. The dental restoration funnel device according to claim 1, further comprising
said foraminous wall having a top surface;
a first divider having a bottom edge extending between and being perpendicular to each of a first edge and a second edge;
said bottom edge being coupled to said top surface of said foraminous floor;
said first divider extending upwardly from said foraminous floor;
said first divider being centrally located on said foraminous floor; and
said first divider bisecting said foraminous floor.

12. The dental restoration funnel device according to claim 11, further comprising:
said cylinder portion having an outer wall;
said outer wall having an inside surface; and
each of said first edge and said second edge being coupled to said inside surface of said outer wall of said cylinder portion of said funnel.

13. The dental restoration funnel device according to claim 11, further comprising;
said funnel having a cylinder portion;
said cylinder portion having an outer wall;
said outer wall having an upper section; and
said first divider having a height being less than a height of said upper section of said outer wall of said cylinder portion of said funnel.

14. The dental restoration funnel device according to claim 11, further comprising:
a second divider having a lower edge extending between and being perpendicular to each of a primary edge and a secondary edge;
said lower edge being coupled to said top surface of said foraminous floor;
said second divider extending upwardly from said foraminous floor;
said second divider being centrally located on said foraminous floor; and
said second divider bisecting said foraminous floor.

15. The dental restoration funnel device according to claim 14, further comprising said second divider being oriented perpendicular to said first divider.

16. The dental restoration funnel device according to claim 15, further comprising said first divider and said second divider defining quadrants of said foraminous floor wherein each of said quadrants is configured to contain a respective one of a plurality of the dental restorations, said second divider having a height being equal to said height of said first divider.

17. A dental restoration funnel device for holding a dental restoration while the dental restoration is being prepared for installation, said device comprising:
a dental suction machine having a high volume suction hose, said high volume suction hose having a sleeve being coupled to said high volume suction hose, said sleeve having a distal end, said distal end being open;
a funnel being removably attachable to said high volume suction hose, said funnel having a foraminous floor wherein said foraminous floor is configured to have the dental restoration placed upon said foraminous floor, said funnel being in fluid communication with said high volume suction hose wherein said foraminous floor is configured to pass air through said foraminous floor and into said high volume suction hose for suctionally removing debris from the dental restoration during preparation of the dental restoration, said funnel having a cylinder portion, said cylinder portion having a bottom wall and an outer wall extending upwardly from said bottom wall, said foraminous floor having a perimeter edge, said outer wall of said cylinder having an inside surface, said perimeter edge being coupled to said inside surface of said outer wall of said cylinder portion, said foraminous floor being spaced from said bottom wall of said cylinder portion, said foraminous floor lying on a plane being oriented parallel to said bottom wall of said cylinder portion, said funnel having a spout portion being coupled to and extending downwardly from said bottom wall of said cylinder portion, said spout portion having a distal end of said spout portion with respect to said bottom wall, said spout portion tapering between said bottom wall and said distal end of said spout portion, said distal end of said spout portion being insertable into said distal end of said sleeve on said high volume suction hose, said sleeve having an interior surface, said spout portion having an outside surface, said outside surface of said spout portion frictionally engaging said interior surface of said sleeve when said distal end of said spout portion is inserted into said distal end of said sleeve for retaining said spout portion in said sleeve, said outer wall of said cylinder portion having a medial section angling outwardly between a lower section and an upper section, said outer wall having a top edge defining an opening into said cylinder portion of said funnel, said lower section intersecting said bottom wall, said medial section being positioned closer to said bottom wall than said top edge of said outer wall, said foraminous floor being aligned with said medial section, said lower section having a diameter being less than a diameter of said upper section, said foraminous floor having a top surface;
a first divider having a bottom edge extending between and being perpendicular to each of a first edge and a second edge, said bottom edge being coupled to said top surface of said foraminous floor, said first divider extending upwardly from said foraminous floor, said first divider being centrally located on said foraminous floor, said first divider bisecting said foraminous floor, each of said first edge and said second edge being coupled to said inside surface of said outer wall of said cylinder portion of said funnel, said first divider having a height being less than a height of said upper section of said outer wall of said cylinder portion of said funnel; and
a second divider having a lower edge extending between and being perpendicular to each of a primary edge and a secondary edge, said lower edge being coupled to said top surface of said foraminous floor, said second divider extending upwardly from said foraminous floor, said second divider being centrally located on said foraminous floor, said second divider bisecting said foraminous floor, said second divider being oriented perpendicular to said first divider, said first divider and said second divider defining quadrants of said foraminous floor wherein each of said quadrants is configured to contain a respective one of a plurality of the dental restorations, said second divider having a height being equal to said height of said first divider.
